(19) United States
(12) Patent Application Publication
(10) Pub. No.: US 2015/0298252 A1
(43) Pub. Date: Oct. 22, 2015

(54) LASER MACHINING METHOD AND LASER MACHINING DEVICE

(71) Applicant: Daisuke KAWAGUCHI, Hamamatsu-shi (JP)

(72) Inventor: Daisuke KAWAGUCHI, Hamamatsu-shi (JP)

(73) Assignee: HAMAMATSU PHOTONICS K.K., Hamamatsu-shi, Shizuoka (JP)

(21) Appl. No.: 14/344,716

(22) PCT Filed: Sep. 7, 2012
(86) PCT No.: PCT/JP2012/072955

§ 371 Date: Apr. 1, 2014

(30) Foreign Application Priority Data
Sep. 16, 2011 (JP) 2011-203396

(51) Int. Cl. B23K 26/00; G05B 19/18

(52) U.S. Cl. CPC B23K 26/0057; G05B 19/182; G05B 2219/36199

(57) ABSTRACT

Laser light L is converged at an object to be processed 1 formed from quartz, so as to provide the object 1 with a modified region 7 including a plurality of modified spots S along a line to cut 5. At this time, the laser light L is relatively moved along the line 5 while irradiating the object 1, so as to form the plurality of modified spots S with a pitch of 2 μm to 9 μm along the line 5. This can optimize the pitch between the plurality of modified spots S to be formed, so as to link fractures favorably to each other between the plurality of modified spots S.

### TECHNICAL FIELD

The present invention relates to a laser processing method and device for cutting an object to be processed.

### BACKGROUND ART

Known as a conventional laser processing method is one converging laser light at an object to be processed, so as to form a modified region in the object along a line to cut, and then cutting the object along the line (see, for example, Patent Literature 1). Such a laser processing method forms a plurality of modified spots along the line and lets the plurality of modified spots produce the modified region.

### CITATION LIST

### Patent Literature

Patent Literature 1: Japanese Patent Application Laid-Open No. 2006-108459

### SUMMARY OF INVENTION

### Technical Problem

When a laser processing method such as the one mentioned above cuts an object to be processed formed from quartz, fractures may fail to link favorably with each other between a plurality of modified spots because of a processing characteristic inherent in quartz, for example, thereby lowering the dimensional accuracy (processing quality) of the object after cutting.

It is therefore an object of the present invention to provide a laser processing method and device which can cut with high dimensional accuracy an object to be processed formed from quartz.

### Solution to Problem

For achieving the above-mentioned object, the inventors conducted diligent studies and, as a result, have found the following knowledge based on the processing characteristic of quartz. That is, it has been found in an object to be processed formed from quartz that, when a plurality of modified spots formed therein have a large pitch therebetween, fractures may fail to link with each other between the modified spots adjacent to each other, whereas a fracture may extend from one modified spot beyond its adjacent modified spot so as to link to the next modified spot (hereinafter referred to as “fracture jump”) when the plurality of modified spots have a narrow pitch therebetween. This has led to an idea that, if a pitch between a plurality of modified spots to be formed can be optimized, fractures can favorably link with each other between the plurality of modified spots, so as to cut the object with high dimensional accuracy, whereby the present invention has been completed.

The laser processing method in accordance with one aspect of the present invention is a laser processing method for cutting an object to be processed formed from quartz along a line to cut, the method comprising a modified region formation step of converging laser light at the object so as to form a modified region including a plurality of modified spots in the object along the line, the modified region formation step including the step of relatively moving the laser light along the line while irradiating the object therewith so as to form the plurality of modified spots along the line; the plurality of modified spots having a pitch of 2 μm to 9 μm therebetween.

This laser processing method can optimize the pitch between a plurality of modified spots to be formed, so as to link fractures favorably to each other between the modified spots. That is, the fracture jump can be restrained from occurring, while securely linking fractures to each other between a plurality of modified spots. As a result, the object can be cut with high dimensional accuracy. If the pitch between the plurality of modified spots is smaller than 2 μm, fractures may link with each other so strongly between the plurality of modified spots that the fracture jump may occur. If the pitch between the plurality of modified spots is greater than 9 μm, on the other hand, fractures may fail to link with each other between the modified spots adjacent to each other.

Here, the plurality of modified spots may have a pitch of 6 μm to 9 μm therebetween. This can further restrain the fracture jump phenomenon from occurring. This can also raise the processing speed, thereby enhancing the productivity. When the pitch is 5 μm or shorter, such fractures are likely to occur as to gouge the inside, thereby lowering the productivity. However, this makes it easier for fractures to occur on the front face side, so as to improve a dividing performance, and thus may be employed for processing an object to be processed which is hard to divide.

The method may further comprise a cutting step of cutting the object from the modified region acting as a cutting start point by applying a force from outside to the object along the line. This makes it possible to cut the object securely along the line.

The laser processing device in accordance with one aspect of the present invention is a laser processing device for cutting an object to be processed formed from quartz along a line to cut, the device comprising a laser light source for oscillating laser light in a pulsating manner; a condenser optical system for converging the laser light oscillated by the laser light source into the object on a support table; and control means for controlling at least the laser light source; the control means executing a modified region formation process of converging laser light at the object so as to form a modified region including a plurality of modified spots in the object along the line, the modified region formation process including the process of relatively moving the laser light along the line while irradiating the object therewith so as to form the plurality of modified spots having a pitch of 2 μm to 9 μm therebetween along the line.

This laser processing device can also link fractures favorably between a plurality of modified spots to be formed, thereby cutting the object with high dimensional accuracy.

### ADVANTAGEOUS EFFECTS OF INVENTION

According to the present invention, objects to be processed formed from quartz can be cut with high dimensional accuracy.

### BRIEF DESCRIPTION OF DRAWINGS

FIG. 1 is a schematic structural diagram of a laser processing device used for forming a modified region;

FIG. 2 is a plan view of an object to be processed for which the modified region is formed;

FIG. 3 is a sectional view of the object taken along the line III-III of FIG. 2;

FIG. 4 is a plan view of the object after laser processing;

FIG. 5 is a sectional view of the object taken along the line V-V of FIG. 4;

FIG. 6 is a sectional view of the object taken along the line VI-VI of FIG. 4;

FIG. 7 is a flowchart illustrating a process of manufacturing a quartz oscillator in accordance with an embodiment;

FIG. 8 is a set of schematic diagrams for explaining a step of cutting the object into quartz chips;

FIG. 9 is a table listing results of evaluating processing characteristics of the object when changing the pitch of modified spots; and

FIG. 10 is a set of photographs observing modified spots in the thickness direction of the object.

### DESCRIPTION OF EMBODIMENTS

In the following, an embodiment of the present invention will be explained in detail with reference to the drawings. In the following explanation, the same or equivalent constituents will be referred to with the same signs while omitting their overlapping descriptions.

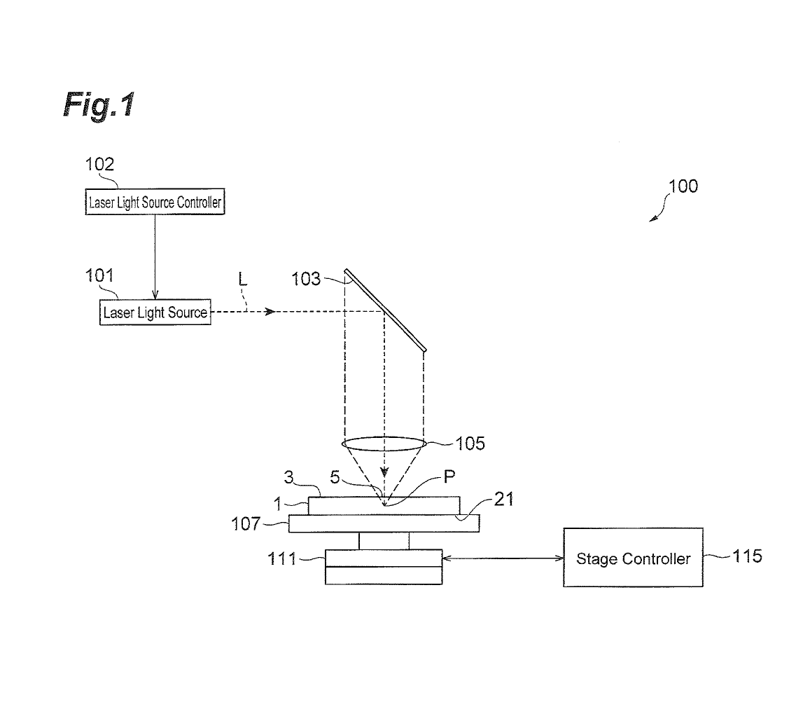

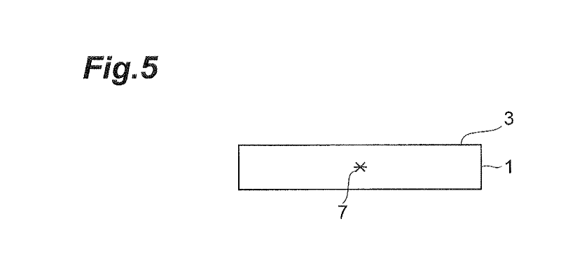

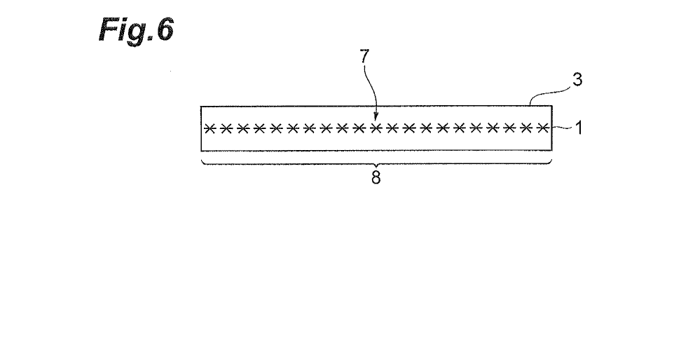

The laser processing method in accordance with the embodiment of the present invention converges laser light at an object to be processed, so as to form a modified region including a plurality of modified spots along a line to cut. Therefore, the forming of the modified region will be explained at first with reference to FIGS. 1 to 6.

As illustrated in FIG. 1, a laser processing device 100 comprises a laser light source 101 for causing laser light L to oscillate in a pulsating manner, a dichroic mirror 103 arranged such as to change the direction of the optical axis (optical path) of the laser light L by 90°, and a condenser lens (condenser optical system) 105 for converging the laser light L. The laser processing device 100 further comprises a support table 107 for supporting an object to be processed 1 which is irradiated with the laser light L converged by the condenser lens 105, a stage 111 for moving the support table 107, a laser light source controller 102 (control means) for regulating the laser light source 101 in order to adjust the output, pulse width, pulse waveform, and the like of the laser light L, and a stage controller 115 for regulating the movement of the stage 111.

In the laser processing device 100, the laser light L emitted from the laser light source 101 changes the direction of its optical axis by 90° with the dichroic mirror 103 and then is converged by the condenser lens 105 into the object 1 mounted on the support table 107. At the same time, the stage 111 is shifted, so that the object 1 moves relative to the laser light L along a line to cut 5. This forms a modified region in the object 1 along the line 5. Though the stage 111 is shifted in order to move the laser light L relatively here, the condenser lens 105 may be moved instead thereof or in addition thereto.

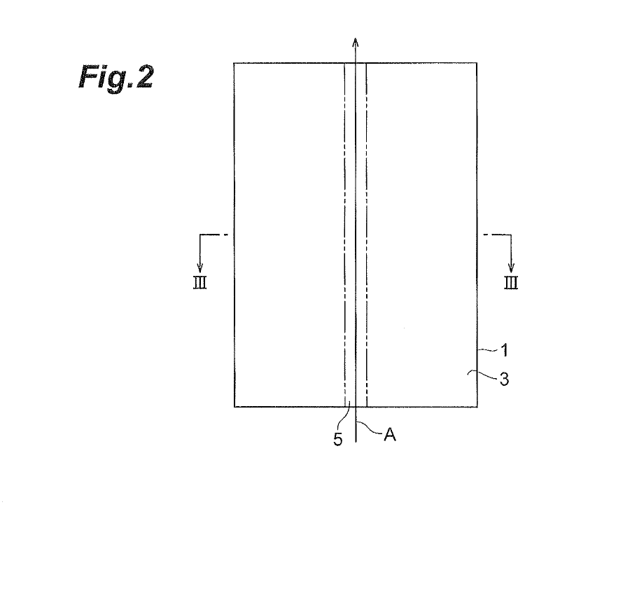

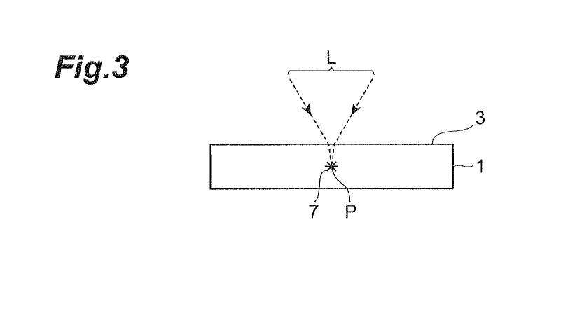

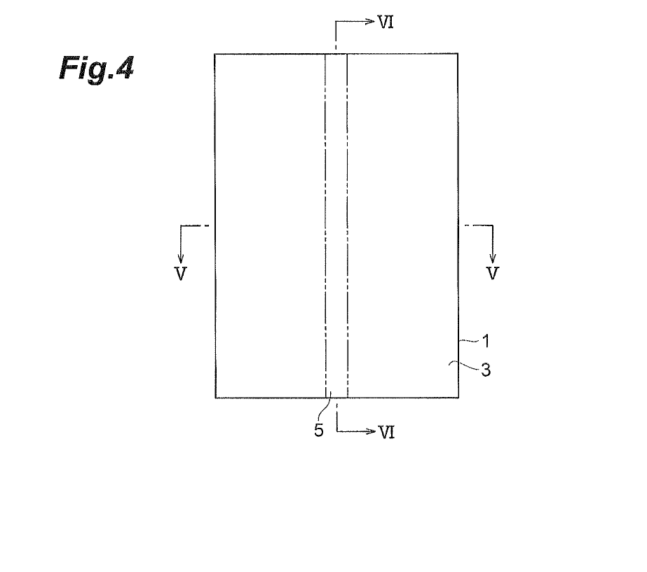

The object 1 is formed from quartz, while the line 5 for cutting it is set therein as illustrated in FIG. 2. The line 5 is a virtual line extending straight. When forming a modified region within the object 1, the laser light L is relatively moved along the line 5 (i.e., in the direction of arrow A in FIG. 2) while locating a converging point (converging position) P within the object 1 as illustrated in FIG. 3. This forms a modified region 7 within the object 1 along the line 5 as illustrated in FIGS. 4 to 6, whereby the modified region 7 formed along the line 5 becomes a cutting start region 8.

The converging point P is a position at which the laser light L is converged. The line 5 may be curved instead of being straight, a three-dimensional combination of lines and curves, or one specified with coordinates. The line 5 may be one actually drawn on a front face 3 of the object 1 without being restricted to the virtual line. The modified region 7 may be formed either continuously or intermittently. The modified region 7 may be formed either in rows or dots, and it is only necessary for the modified region 7 to be formed at least within the object 1. There are cases where fractures are formed from the modified region 7 acting as a start point, and the fractures and modified region 7 may be exposed at outer surfaces (the front face 3, rear face 21, and outer peripheral surface) of the object 1. The laser light entrance surface for forming the modified region 7 is not limited to the front face 3 of the object 1, but may be the rear face 21 of the object 1.

Here, the laser light L is absorbed in particular in the vicinity of the converging point within the object 1 while being transmitted therethrough, whereby the modified region 7 is formed in the object 1 (internal absorption type laser processing). Therefore, the front face 3 of the object 1 hardly absorbs the laser light L and thus does not melt. In the case of forming a removing part such as a hole or groove by melting it away from the front face 3 (surface absorption type laser processing), the processing region gradually progresses from the front face 3 side to the rear face side in general.

By the modified region formed in this embodiment are meant regions whose physical characteristics such as density, refractive index, and mechanical strength have attained states different from those of their surroundings. Examples of the modified region include molten processed regions (meaning at least one of a region resolidified after melting, a region in a melted state, and a region in the process of resolidifying from the melted state), crack regions, dielectric breakdown regions, refractive index changed regions, and their mixed regions. Other examples of the modified region include areas where the density of the modified region has changed from that of an unmodified region and areas formed with a lattice defect in a material of the object (which may also collectively be referred to as high-density transitional regions).

The molten processed regions, refractive index changed regions, areas where the modified region has a density different from that of the unmodified region, or areas formed with a lattice defect may further incorporate a fracture (fissure or microcrack) therewithin or at an interface between the modified and unmodified regions. The incorporated fracture may be formed over the whole surface of the modified region or in only a part or a plurality of parts thereof. As the object 1, quartz (SiO₂) or a material containing quartz is used.

This embodiment forms a plurality of modified spots (processing scars) along the line 5, thereby producing the modified region 7. The modified spots, each of which is a modified part formed by a shot of one pulse of pulsed laser light (i.e., one pulse of laser irradiation; laser shot), gather to yield the modified region 7. Examples of the modified spots include crack spots, molten processed spots, refractive index changed spots, and those in which at least one of them is mixed.

Preferably, for the modified spots, their sizes and lengths of fractures generated therefrom are controlled as appropriate in view of the required cutting accuracy, the demanded flatness of cut surfaces, the thickness, kind, and crystal orientation of the object, and the like.

This embodiment will now be explained in detail.

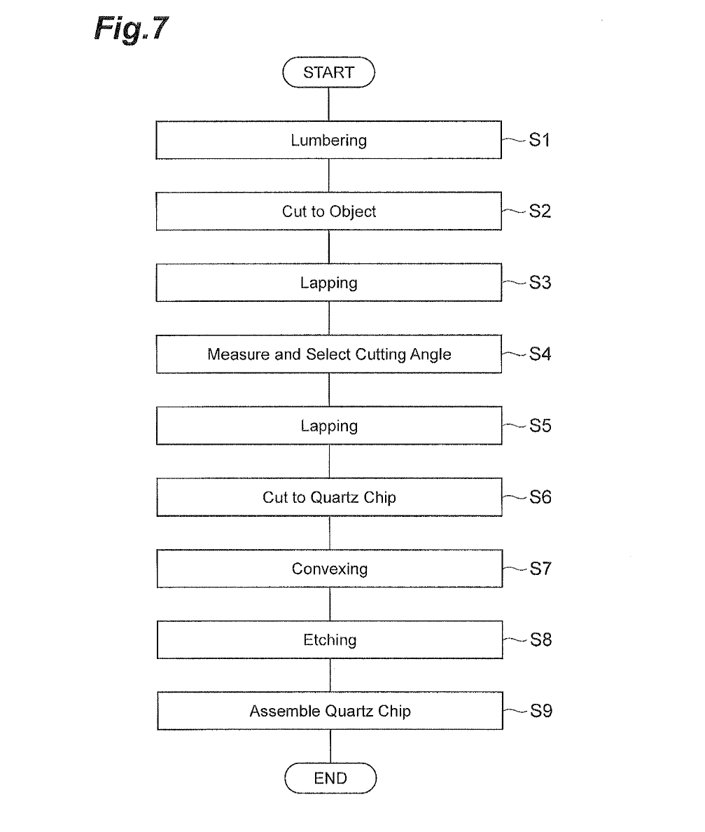

This embodiment is used as a quartz oscillator manufacturing method for manufacturing a quartz oscillator, for example, and cuts the object 1 formed from quartz, which is a hexagonal crystal, into a plurality of crystal chips. Therefore, a total manufacturing process flow of the quartz oscillator will firstly be explained in brief with reference to FIG. 7.

First, a synthetic quartz gemstone is cut out by grinding with diamond, for example, so as to be processed into a bar-shaped body (lumbered bar) having a predetermined size (S1). Subsequently, a cutting angle corresponding to a temperature characteristic required for the quartz oscillator is measured by X-rays, and the lumbered bar is cut according to the cutting angle by wire sawing into a plurality of wafer-shaped objects 1 (S2). Here, each object 1 is formed into a rectangular plate of 10 mm×10 mm and has a crystal axis tilted by 35.15° from the thickness direction.

Next, the front and rear faces 3, 21 of the object 1 are subjected to lapping until it attains a predetermined thickness (S3). Subsequently, the cutting angle is measured at a minute angle level by X-rays, so as to select and classify the object 1, and then the front and rear faces 3, 21 of the object 1 are subjected again to lapping similar to the above-mentioned S3, so as to minutely adjust the thickness of the object 1 to about 100 μm, for example (S4, S5).

Subsequently, as processing for cutting and outer shaping, the object 1 is formed with a modified region 7 and cut along the lines 5 from the modified region 7 acting as a cutting start point (S6, which will be explained later in detail). This produces a plurality of quartz chips having a dimensional accuracy of ±several μm or finer. In this embodiment, the lines 5 are set like grids on the object 1 when seen from above the front face 3, whereby the object 1 is cut into rectangular plate-like quartz chips each having a size of 1 mm×0.5 mm.

Next, the quartz chip is subjected to chamfering (convexing) so as to attain a predetermined frequency, and its thickness is also adjusted by etching so as to conform to the predetermined frequency (S7, S8). Thereafter, the quartz chip is assembled as a quartz oscillator (S9). Specifically, electrodes are formed on the quartz chip by sputtering, the quartz chip is mounted in a mounter and heat-treated in a vacuum, the electrodes on the quartz chip are thereafter shaved so as to adjust the frequency, and then the inside of the mounter is sealed by seaming. This completes the manufacture of the quartz oscillator.

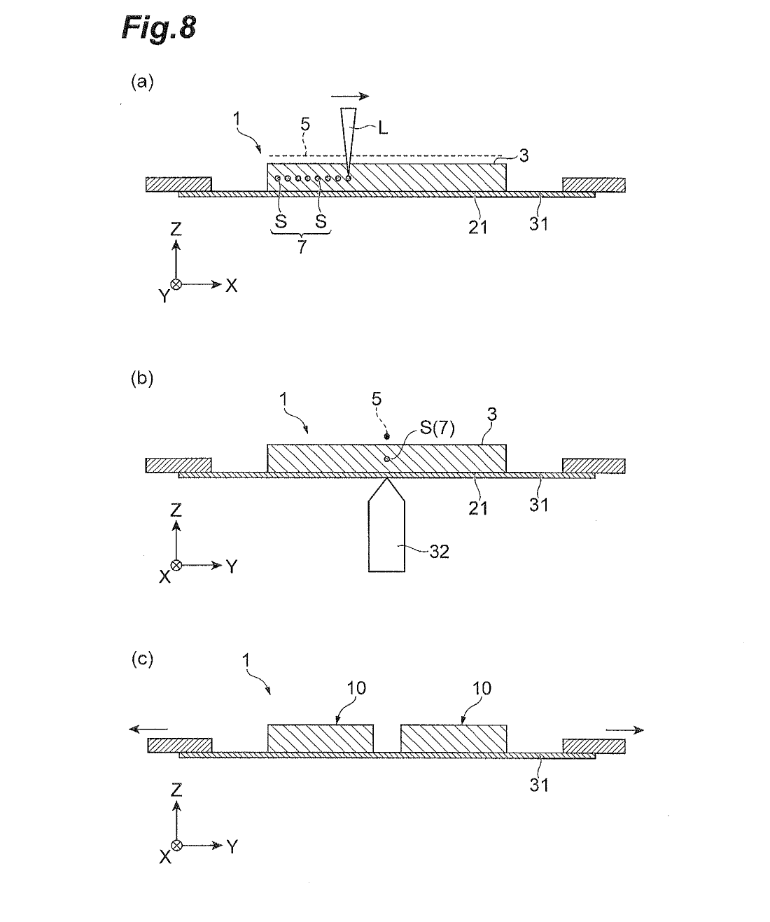

FIG. 8 is a set of schematic diagrams for explaining a process of cutting the object into the quartz chip. For convenience of explanation, these diagrams exemplify cutting along one line 5. At the above-mentioned S6 for cutting the object 1 into the quartz chip, the object 1 having an expandable tape 31 attached to the rear face 21 thereof is firstly mounted on the support table 107 (see FIG. 1).

Subsequently, the laser light source controller 102 controls the laser light source 101, while the stage controller 115 controls the stage 111, so as to converge the laser light L at the object 1 along the line 5 as appropriate, thereby forming the modified region 7 including a plurality of modified spots S (modified region formation process (modified region formation step)).

Specifically, as FIG. 8(a) illustrates, the object 1 is irradiated with the laser light L from the front face 3 side at an output of 0.03 W, a repetition frequency of 15 kHz, and a pulse width of 500 or 640 psec, for example, while locating the converging point therewithin at a depth of 15 μm from the front face 3. Concurrently, the laser light L is moved relative to the object 1 (scan). This forms a plurality of modified spots S within the object 1 along the line 5 and lets the plurality of modified spots S produce the modified region 7. The above-mentioned scan is performed for all the lines 5.

At this time, the relative movement speed of the laser light L is controlled so as to regulate the distance, i.e., pitch (also referred to as pulse pitch), between the modified spots S adjacent to each other in the direction along the line 5. Here, the pitch between the plurality of modified spots S is preferably 2 μm to 9 μm, more preferably 6 μm to 9 μm.

Next, as FIG. 8(b) illustrates, a knife edge 32 is pressed against the object 1 along the line 5 from the rear face 21 side with the expandable tape 31 interposed therebetween, so as to apply a force from the outside to the object 1 along the line 5 (cutting step). This cuts the object 1 into a plurality of quartz chips from the modified region 7 acting as a cutting start point. Then, as FIG. 8(c) illustrates, the expandable tape 31 is expanded, so as to secure a chip interval. The foregoing cuts the object 1 into a plurality of quartz chips 10.

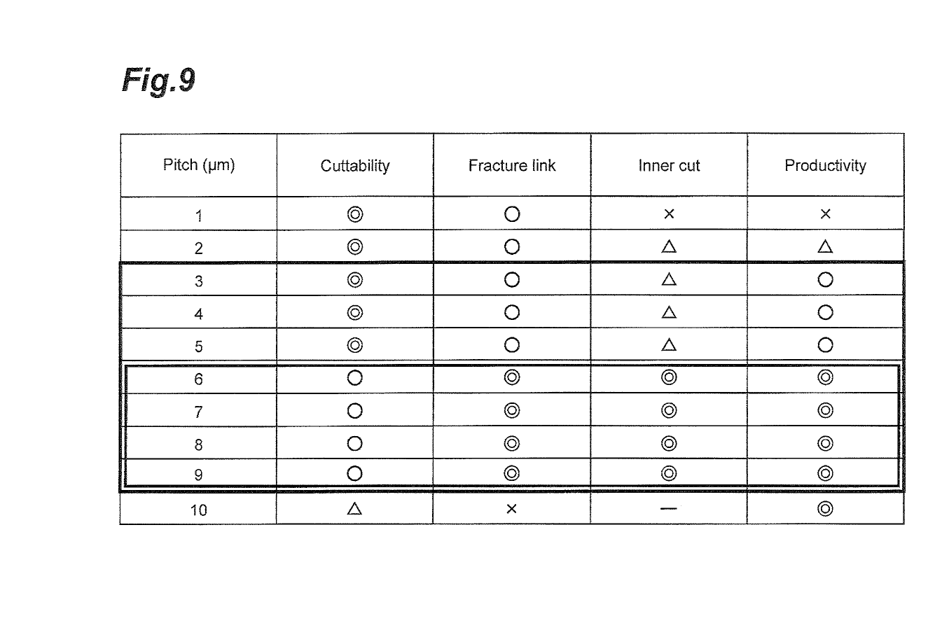

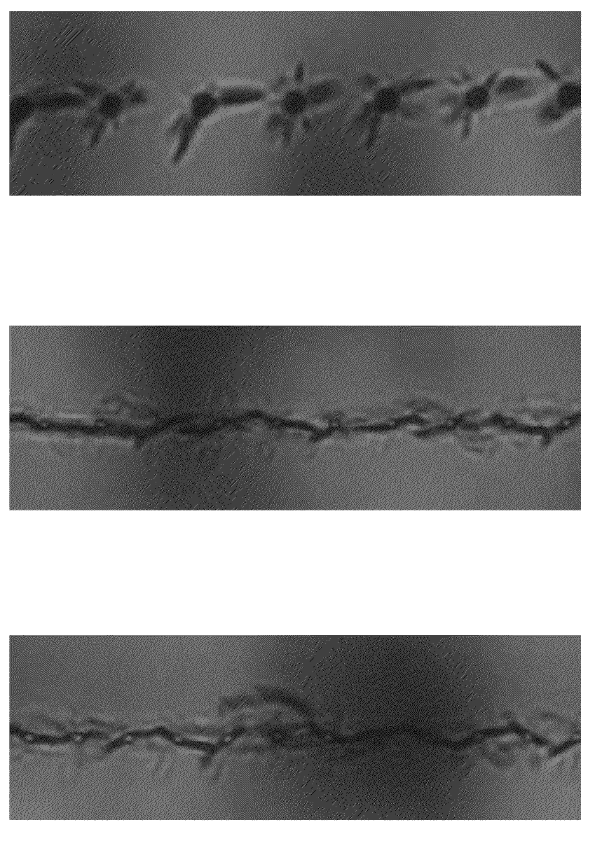

FIG. 9 is a table listing results of evaluating processing characteristics of the object when changing the pitch of modified spots, while FIG. 10 is a set of cross-sectional photographs capturing a plurality of modified spots formed in the object as seen in the thickness direction of the object. In FIG. 9, “Inner cut” evaluates the amount of gouges cutting the inside by gouging, in which signs of cross, triangle, double circle, and dash indicate the respective cases where a gouge of 10 μm or greater occurred, a gouge not reaching 10 μm at most occurred, no gouge occurred, and cutting itself was difficult. FIGS. 10(a), 10(b), and 10(c) illustrate a plurality of modified spots having pitches of 10 μm or greater, 2 μm to 9 μm, and 1 μm or smaller, respectively. Such a gouge, if any, lowers the controllability of the etching amount in the subsequent etching for manufacturing the quartz oscillator, for example, thereby making it harder to manufacture highly accurate devices.

It is seen from FIGS. 9 and 10(a) that fractures C occurring from the modified spots S adjacent to each other fail to link with each other when the pitch of the modified spots S is 10 μm or greater. It is also seen that the occurring fractures C become too large, while the advancing direction of the fractures C is uncontrollable. This lowers the cuttability, yields insufficient fracture links, and makes the object 1 harder to cut. As a result, the cutting quality deteriorates at the time of cutting and etching.

When the pitch of the modified spots S is 1 μm or smaller, on the other hand, it is seen from FIGS. 9 and 10(c) that the cuttability and fracture link are unproblematic, but the modified spots S link so much as to generate such a fracture jump that the fracture C occurring from one modified pot S extends beyond its adjacent spot S to link to the next modified spot, thereby producing a gouge E cutting the inside by gouging. Under the influence of this gouge E, the object is harder to cut with high dimensional accuracy, whereby the cutting quality deteriorates. This also slows down the processing speed, thereby lowering the productivity (throughput).

When the pitch of the modified spots S is 2 μm to 9 μm, by contrast, it is seen from FIGS. 9 and 10(b) that not only the cuttability and fracture link are unproblematic, but also the gouge E is restrained from occurring, whereby the fractures C link favorably with each other between a plurality of modified spots S. Specifically, the fractures C occurring from the respective modified spots S act so as to cancel each other out without becoming large fractures and link with each other so as to extend in the direction along the line 5 (the horizontal direction in FIG. 10(b); processing method).

Therefore, as mentioned above, this embodiment controls the pitch of the modified spots S so as to optimize it to a favorable range of 2 μm to 9 μm. This can suppress the occurrence of jumps in the fractures C and the inner cut (gouge E), while favorably linking the fractures C to each other between a plurality of modified spots S, S, thereby allowing the object 1 to be cut with high dimensional accuracy.

Since the quartz oscillator is a device which utilizes a characteristic of a quartz material per se, its temperature and oscillator characteristics are greatly influenced by the dimensional accuracy of a quartz chip for the quartz oscillator. In this regard, this embodiment, which can cut the object 1 with high dimensional accuracy as the quartz chip, is effective in particular.

It is seen from FIG. 9 that the fracture link and inner cut are favorable in particular when the pitch of the modified spots S is 6 μm to 9 μm, whereby the fractures C link with each other more favorably between a plurality of modified spots S. In addition, it is seen in this case that the pitch can be made relatively wider, so as to raise the processing speed at the time of forming a plurality of modified spots S, thereby enhancing the productivity. Therefore, as mentioned above, this embodiment controls the pitch so as to further optimize it to a more preferred range of 2 μm to 9 μm, which makes it possible to cut the object 1 with higher dimensional accuracy and enhance the productivity.

As mentioned above, this embodiment applies an external stress to the object 1 along the line 5 by using the knife edge 32, so as to cut the object 1 from the modified region 7 acting as a cutting start point. Hence, even the object 1 formed from quartz which is hard to cut can securely be cut along the line 5 with accuracy.

Though a preferred embodiment of the present invention is explained in the foregoing, the present invention is not limited to the above-mentioned embodiment but may be modified or applied to others within the scope not altering the gist set forth in each claim,

For example, while the above-mentioned embodiment controls the pitch of modified spots S by regulating the relative movement speed of the laser light L with respect to the object 1, it is not restrictive as long as the pitch of modified spots S can be set to 2 μm to 9 μm or 6 μm to 9 μm. It is not necessary for all the pitches of the plurality of modified spots S to become 2 μm to 9 μm or 6 μm to 9 μm, but at least a part of them may do so.

In the foregoing, values of pitches in the plurality of modified spots S can tolerate errors in processing, manufacture, design, and the like. The present invention, which can be regarded as a quartz oscillator manufacturing method or device for manufacturing a quartz oscillator by the above-mentioned laser processing method, is not limited to those for manufacturing quartz oscillators, but is also applicable to various methods or devices for cutting objects to be processed formed from quartz.

### INDUSTRIAL APPLICABILITY

Objects to be processed formed from quartz can be cut with high dimensional accuracy.

### REFERENCE SIGNS LIST

1 . . . object to be processed; 5 . . . line to cut; 7 . . . modified region; 100 . . . laser processing device; 101 . . . laser light source; 102 . . . laser light source controller (control means); 105 . . . condenser lens (condenser optical system); 107 . . . support table; L . . . laser light; S . . . modified spot

1. A laser processing method for cutting an object to be processed formed from quartz along a line to cut;
the method comprising a modified region formation step of converging laser light at the object so as to form a modified region including a plurality of modified spots in the object along the line;
the modified region formation step including the step of relatively moving the laser light along the line while irradiating the object therewith so as to form the plurality of modified spots along the line;
wherein the plurality of modified spots have a pitch of 2 μm to 9 μm therebetween.

2. A laser processing method according to claim 1, wherein the plurality of modified spots have a pitch of 6 μm to 9 μm therebetween.

3. A laser processing method according to claim 1, further comprising a cutting step of cutting the object from the modified region acting as a cutting start point by applying a force from outside to the object along the line.

4. A laser processing device for cutting an object to be processed formed from quartz along a line to cut, the device comprising:
a laser light source for oscillating laser light in a pulsating manner;
a condenser optical system for converging the laser light oscillated by the laser light source into the object on a support table; and
control means for controlling at least the laser light source;
the control means executing a modified region formation process of converging laser light at the object so as to form a modified region including a plurality of modified spots in the object along the line;
wherein the modified region formation process includes the process of relatively moving the laser light along the line while irradiating the object therewith so as to form the plurality of modified spots having a pitch of 2 μm to 9 μm therebetween along the line.
